(19) United States
(12) Patent Application Publication
(10) Pub. No.: US 2024/0286850 A1
(43) Pub. Date: Aug. 29, 2024

(54) ROTARY TABLE DEVICE

(71) Applicant: NIPPON THOMPSON CO., LTD., Tokyo (JP)

(72) Inventors: Daisuke TAKASHIMA, Toki-shi (JP); Tetsuya SAKAI, Toki-shi (JP)

(73) Assignee: NIPPON THOMPSON CO., LTD., Tokyo (JP)

(21) Appl. No.: 18/693,177

(22) PCT Filed: Jun. 23, 2022
(86) PCT No.: PCT/JP2022/025099

§ 371 Date: Mar. 19, 2024

(30) Foreign Application Priority Data
Sep. 24, 2021 (JP) 2021-155406

(51) Int. Cl. B65G 47/80; H02K 7/08; H02K 11/22; H02K 21/24

(52) U.S. Cl. CPC B65G 47/80; H02K 7/086; H02K 11/22; H02K 21/24

(57) ABSTRACT

A rotary table device which includes a base portion, a bearing, a table rotatably supported with respect to the base portion via the bearing, and a motor operable to rotate the table in a rotational direction of the bearing. The motor includes a coil row fixed to the base portion and having a plurality of flat, annularly wound three-phase coreless coils arranged side by side, and a magnet row arranged opposite to the coil row and fixed to the table, and having a plurality of plate-shaped magnets arranged side by side in a circumferential direction of the table with alternating magnetic poles. The table has an outer circumferential surface on which a scale is printed around the entire circumference. A sensor for reading the scale is mounted on the base portion.

### TECHNICAL FIELD

The present invention relates to a rotary table device. The present application claims priority based on Japanese Patent Application No. 2021-155406 filed on Sep. 24, 2021, the entire contents of which are incorporated herein by reference.

### BACKGROUND ART

A rotary table device including a bed as a fixed portion, a disk-shaped rotary table, and a bearing interposed therebetween, and being rotationally driven by a linear motor is known. The linear motor is composed of armature coils, which are flat, annularly wound three-phase coreless coils, and a field magnet, which is made up of a large number of plate-shaped magnets. For example, in a rotary table device of Patent Literature 1, the coils are fixed to the bed, the magnets are fixed to the rotary table, and the coils and the magnets are arranged so as to face each other. In this rotary table device, a tape-shaped scale is adhered to the outer circumferential surface of the table within a range corresponding to the rotation angle of the table. An optical sensor placed at the bed reads the scale to thereby detect the position of the table.

As a rotary table device, an infinite rotary table device is known in which the table rotates, not limited to within a certain rotation angle, but over an angle of 360° or more. For example, Patent Literature 2 discloses a rotary table device in which the table rotates infinitely with respect to the bed. In the rotary table device of Patent Literature 2, a ring-shaped scale is fitted to the shaft portion of the table. A ring member provided with the scale around its entire circumference is inserted on the outer circumferential side of the shaft portion of the table and fixed to the table with screws.

### CITATION LIST

### Patent Literature

Patent Literature 1: Japanese Patent Application Laid-Open No. 2004-72960
Patent Literature 2: Japanese Patent Application Laid-Open No. 2020-120430

### SUMMARY OF INVENTION

### Technical Problem

There is a need for a compact rotary table device of stable quality that can be produced with rational steps. Therefore, one of the objects is to provide a rotary table device that is compact, has stable quality, and can be produced with rational steps.

### Solution to Problem

A rotary table device according to the present disclosure includes a base portion, a bearing, a table rotatably supported with respect to the base portion via the bearing, and a motor operable to rotate the table in a rotational direction of the bearing. The motor includes a coil row fixed to the base portion and having a plurality of flat, annularly wound three-phase coreless coils arranged side by side, and a magnet row arranged opposite to the coil row and fixed to the table, and having a plurality of plate-shaped magnets arranged side by side in a circumferential direction of the table with alternating magnetic poles. The table has an outer circumferential surface on which a scale is printed around the entire circumference. A sensor for reading the scale is mounted on the base portion.

### Advantageous Effects of Invention

According to the rotary table device described above, a rotary table device is provided that is compact, has stable quality, and can be produced with rational steps.

### BRIEF DESCRIPTION OF DRAWINGS

FIG. 1 is a perspective view of a rotary table device of Embodiment 1.

FIG. 2 is a cross-sectional view of the rotary table device of Embodiment 1.

FIG. 3 is a partial, enlarged cross-sectional view of the rotary table device of Embodiment 1.

FIG. 4 is a perspective view of a bed of the rotary table device of Embodiment 1.

FIG. 5 is a plan view of the bed and members fixed to the bed of the rotary table device of Embodiment 1.

FIG. 6 is a perspective view of the bed and the members fixed to the bed of the rotary table device of Embodiment 1.

FIG. 7 is a plan view of a table of the rotary table device of Embodiment 1.

FIG. 8 is a perspective cross-sectional view of the table of the rotary table device of Embodiment 1.

FIG. 9 is a plan view of the table and a magnet row of the rotary table device of Embodiment 1.

FIG. 10 is a perspective view of a rotary body and a bearing of Embodiment 2.

FIG. 11 is a perspective cross-sectional view of the rotary body and the bearing of Embodiment 2.

FIG. 12 is a perspective cross-sectional view of the rotary body of Embodiment 2.

### DESCRIPTION OF EMBODIMENTS

### [Outline of Embodiments]

First, embodiments of the present disclosure will be listed and described. A rotary table device according to the present disclosure includes a base portion, a bearing, a table rotatably supported with respect to the base portion via the bearing, and a motor operable to rotate the table in a rotational direction of the bearing. The motor includes a coil row fixed to the base portion and having a plurality of flat, annularly wound three-phase coreless coils arranged side by side, and a magnet row arranged opposite to the coil row and fixed to the table, and having a plurality of plate-shaped magnets arranged side by side in a circumferential direction of the table with alternating magnetic poles. The table has an outer circumferential surface on which a scale is printed around the entire circumference. A sensor for reading the scale is mounted on the base portion.

Conventionally, rotary table devices are known which are used for the purpose of attaching a workpiece or the like as another component to a table and rotating the workpiece. As such rotary table devices, a rotary table device driven by a direct drive servomotor is known. A rotary table device that reciprocates within a certain rotation angle range of, for example, 60°, 150°, or the like is known. An infinite rotary table device that rotates 360° or more is also known. In any case, the device is often provided with a position detection mechanism in which a sensor fixed to the base reads graduations of a scale provided on the table to thereby detect the position of the table.

Known methods of attaching a scale to a table include a method of adhering a tape with graduations marked thereon to the outer circumferential surface of the table, and a method of fitting a ring with graduations marked thereon (a ring scale) onto the outer circumference of the table. Here, in an infinite rotary table device, it is necessary to place the scale over the entire circumference of the outer circumferential surface of the table. In the case of applying a tape-type scale to infinite rotary table devices, the vertical position, horizontal position, phase, origin position, and the like for attaching the tape need to be precisely adjusted for each table device, which would require man-hours and skill. It was also inevitable that tape joints would be formed. Therefore, in an infinite rotary table device, it has been proposed to attach a ring scale provided with a scale to the table (for example, Patent Literature 2).

On the other hand, a ring scale has a thickness of several millimeters to about 10 millimeters in the radial direction. Therefore, particularly in the case of a small infinite rotary table device, providing the installation space for the ring scale makes the installation spaces for magnets and coil modules relatively small, making it difficult to obtain sufficient torque. Under these circumstances, investigations were conducted repeatedly, and the idea of printing the scale directly on the outer circumferential surface of the table around the entire circumference was conceived.

The rotary table device according to the present disclosure provides a rotary table device of small size and stable quality through rational production steps, which does not require the installation space for a scale member and does not require a tape to be attached. With the configuration in which the scale is printed on the outer circumferential surface of the table, the number of components can be reduced, the assembly is facilitated, and excellent stability in quality is ensured because errors due to accumulated tolerances in the components are reduced. Furthermore, by eliminating the use of the scale member, the eccentricity of the rotating section is suppressed, so that the accuracy is maintained and the quality is stabilized.

In the above rotary table device, the coil row may be a row of the coreless coils arranged to constitute a portion of an annular ring, and the magnet row may be an annular row of the magnets arranged around the entire circumference of the table. According to this configuration, an infinite rotary table device in which the rotation angle is not limited within a certain range is obtained.

In the above rotary table device, the table may include a disk-shaped placement portion having an upper surface formed to be flat, and a shaft portion located below the placement portion and having a smaller diameter than the placement portion. The scale may be printed on an outer circumferential surface of the shaft portion, and an encoder head including the sensor may be placed on the base portion such that the encoder head as a whole is positioned under the placement portion. According to this configuration, the rotary table device as a whole can be reduced in size, while securing the size of the placement portion of the table.

In the above rotary table device, graduations constituting the scale may be recesses formed on the outer circumferential surface of the shaft portion with lengths of 0.2 mm to 10 mm and depths of 0.1 μm to 100 μm. Such scale graduations can be produced by laser machining or other general-purpose production techniques, and provide sufficient sensor reading accuracy.

In the above rotary table device, the table and an outer ring of the bearing may be configured as a one-piece component. According to the configuration in which the table and the outer ring of the bearing are configured as a one-piece component and the scale is printed on the outer circumferential surface of the table, the number of components can be further reduced, and adjustment of the assembly becomes unnecessary. Machining of the raceway surfaces on the outer ring of the bearing and machining of the outer circumferential surface of the table can be performed in one chucking, so a high-precision rotary table device can be obtained with rational production steps.

### Specific Embodiments

Specific embodiments of the rotary table of the present disclosure will now be described with reference to the drawings. In the drawings referenced below, the same or corresponding portions are denoted by the same reference numerals and the description thereof will not be repeated.

### Embodiment 1

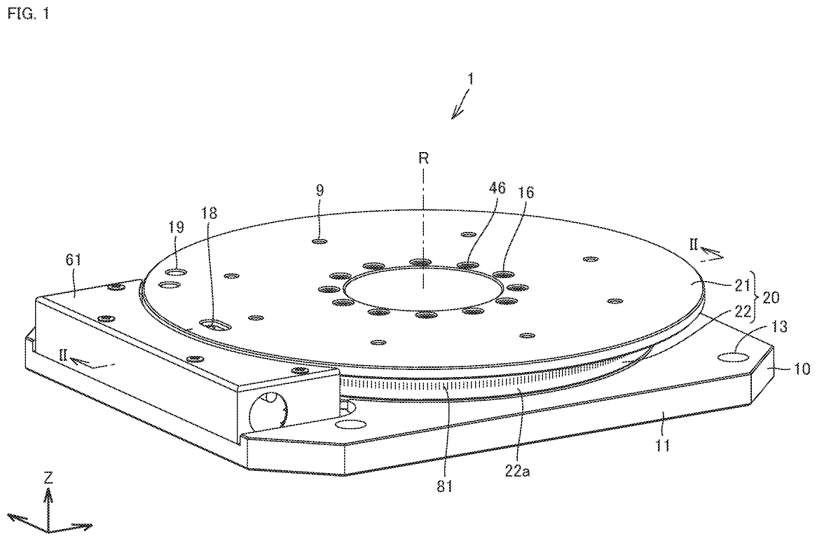

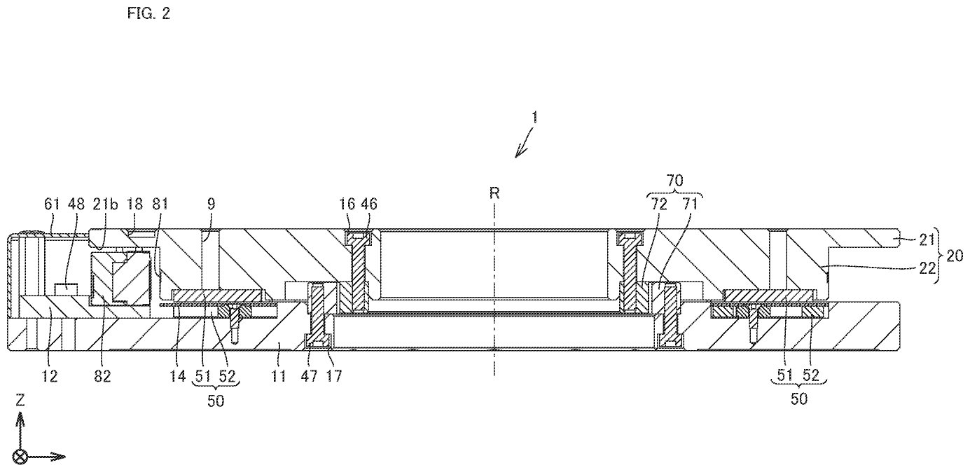

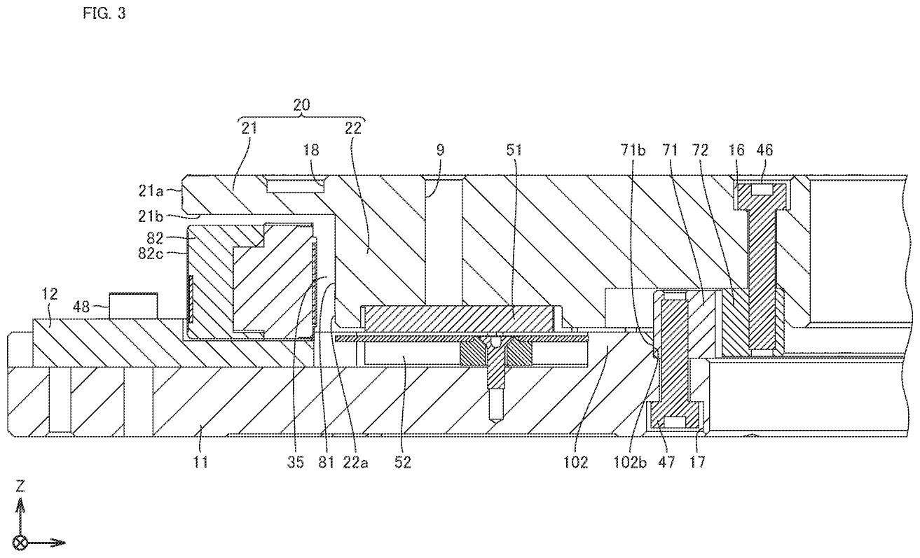

FIG. 1 is a schematic perspective view showing the structure of a rotary table device 1 of Embodiment 1. In FIG. 1, the Z axis direction is a direction in which a rotational axis R of a table (rotational axis of a bearing) of the rotary table device extends. FIG. 2 is a cross-sectional view of the rotary table device 1 cut along II-II in FIG. 1. FIG. 3 is an enlarged cross-sectional view of a portion of FIG. 2 with some members omitted.

First, a schematic configuration of the rotary table device 1 will be described.

Referring to FIG. 1, the rotary table device 1 of Embodiment 1 includes a base portion 10, which is a fixed portion, and a table 20, which is rotatable with respect to the base portion 10. The base portion 10 includes a bed 11. The bed 11 has a cover 61 fixed thereto. The cover 61 is for covering an encoder head 82 (FIG. 2). The cover 61 ensures high reading accuracy of an optical sensor in the encoder head 82 and also prevents dust from entering the sensor section.

The table 20 is rotatable about the rotational axis R. The table 20 includes a placement portion 21, which is a hollow, disk-shaped portion, and a shaft portion 22 located below the placement portion 21. The shaft portion 22 has an outside diameter smaller than that of the placement portion 21. The placement portion 21 has an upper surface formed to be flat. The placement portion 21 and the shaft portion 22 are integrally formed to constitute a single component. The shaft portion 22 has an outer circumferential surface 22a on which a scale 81 is printed around the entire circumference.

The placement portion 21 has a plurality of screw holes 9 formed to penetrate through the placement portion 21 in a thickness direction (Z axis direction). The screw holes 9 are utilized for attaching a workpiece as an external component. In the rotary table device 1, eight screw holes 9 are formed at equal intervals in the circumferential direction, although the number is not particularly limited. The placement portion 21 also has a plurality of screw holes 16 formed to penetrate through the placement portion 21 in the thickness direction. Screws 46 are inserted in the screw holes 16.

The placement portion 21 is provided with a mounting hole 18 to which a reference mark for generating an origin signal can be attached. The placement portion 21 is also provided with a mounting hole 19 to which a sensor dog for a pre-origin sensor or the like can be attached. In the rotary table device of the present disclosure, the reference mark and the pre-origin sensor are not indispensable, so the mounting holes 18 and 19 do not have to be utilized. The placement portion may not be provided with the mounting holes 18 and 19.

Referring to FIG. 2, the rotary table device 1 includes a bearing 70. The bearing 70 is, for example, a crossed roller bearing. In FIG. 2, the rolling elements of the bearing 70 are not shown. The bearing 70 has an outer ring 71 fixed to the bed 11. Screws 47 are inserted in screw holes 17 that penetrate from an underside of the bed 11 in the thickness direction. The screws 47 secure the outer ring 71 to the bed 11. An inner ring 72 is fixed to the table 20. The screws 46 secure the inner ring 72 to the table 20. In other words, the table 20 is rotatably supported with respect to the base portion 10 via the bearing 70.

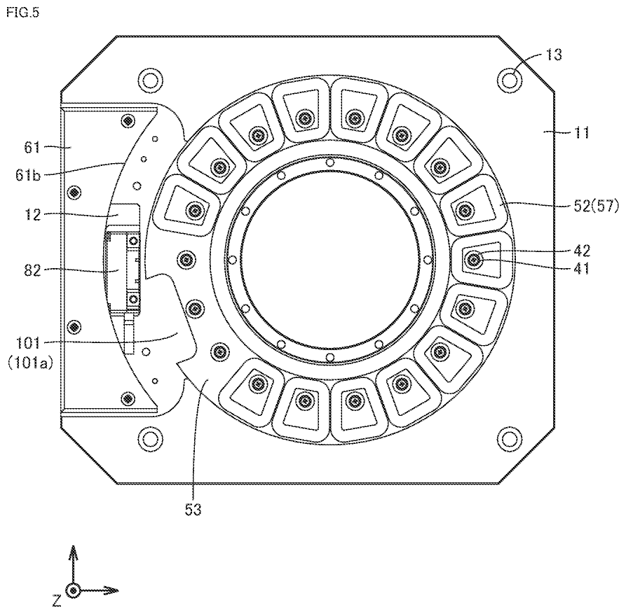

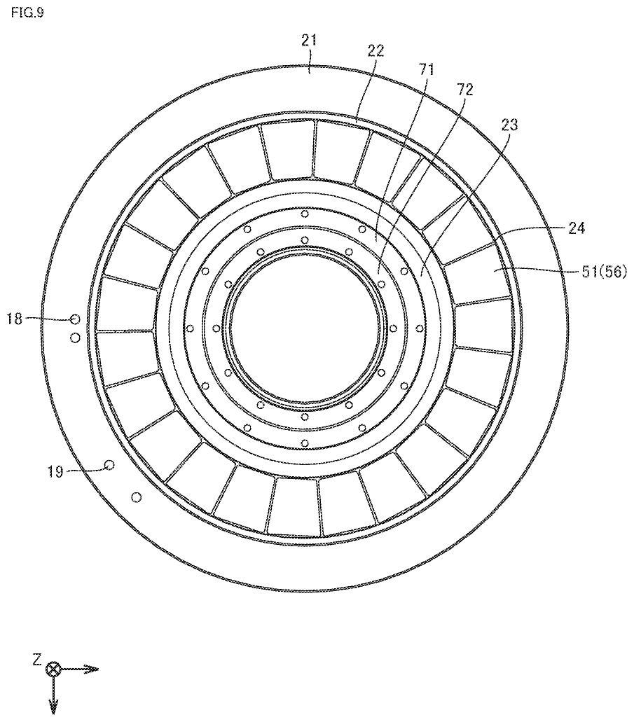

The table 20 has an underside to which magnets 51 are attached. Coils 52, which are coreless coils, are attached to positions on the bed 11 facing the magnets 51. A plurality of magnets 51 are arranged side by side in the circumferential direction of the table 20 to form a magnet row 56 (FIG. 9). A plurality of coils 52 are arranged at positions corresponding to the magnet row 56 to form a coil row 57 (FIG. 5). When a current flows through the coils 52, a motor 50 composed of the magnets 51 and the coils 52 operates to generate a torque, so the table 20 rotates.

The bed 11 has a support base 12 attached thereto with screws 48. The encoder head 82 is fixed on the support base 12. The encoder head 82 is disposed under a bottom surface 21b of the placement portion 21 of the table 20, i.e., the portion where the placement portion 21 projects outwardly from the shaft portion 22. The encoder head 82 is covered with the cover 61. As used herein, “outwardly” means a direction away from the rotational axis R of the table 20.

Referring to FIG. 3, the bed 11 includes a first annular portion 102 having a center coincident with the rotational axis R (FIG. 2). The first annular portion 102 is a relatively thick portion compared to the surrounding regions. The outer ring 71 of the bearing 70 has an outer circumferential surface 71b in close contact with an inner circumferential surface 102b of the first annular portion 102. The outer ring 71 is spigot-fitted to the bed 11.

The scale 81 is printed on the outer circumferential surface 22a of the shaft portion 22 of the table 20. The encoder head 82 is positioned opposite to the scale 81. Between the scale 81 and the encoder head 82, a gap 35 is formed in which the sensor of the encoder head 82 can read the graduations of the scale. The gap 35 has a width that is substantially the same irrespective of the size of the entire device or the arrangement of the components so as to enable the reading of the graduations of the scale. For example, for a rotary table device in which the placement portion 21 of the table 20 has an outside diameter of 65 mm, the size of the bed 11 can be on the order of 65 mm to 75 mm×75 mm to 85 mm. A rear surface 82c of the encoder head 82 does not protrude outwardly from an outer circumferential surface 21a of the placement portion 21. In other words, the encoder head 82 is accommodated under the placement portion 21. The rotary table device 1 does not have a ring scale, and the scale 81 is printed directly on the table. This allows the table and the sensor to be arranged in close proximity to each other. With this configuration, the rotary table device can be reduced in size. Improvement in reading accuracy of the sensor is also expected. Further, with the configuration in which the encoder head 82 is accommodated under the placement portion 21, a rotary table device can be obtained which is reduced in size as a whole while securing the area of the placement portion 21.

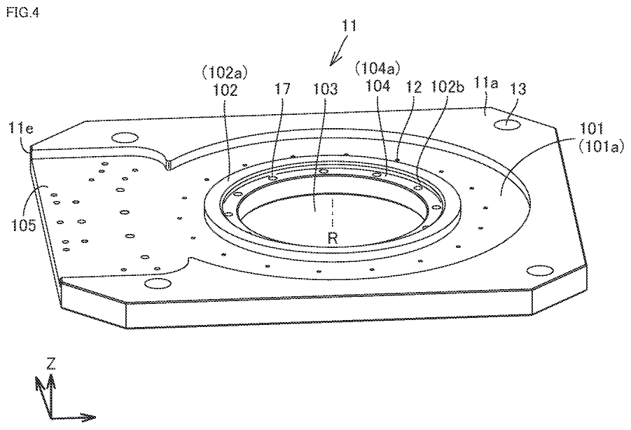

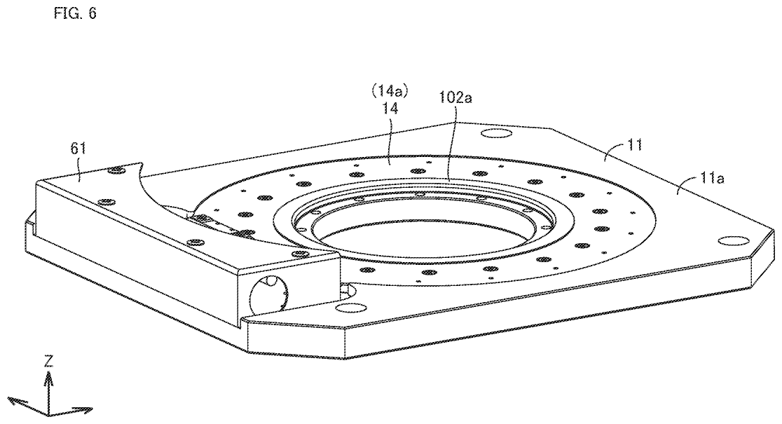

The fixed side of the rotary table device, i.e., the base portion 10 and the members fixed to the base portion 10 of the rotary table device 1, will now be described in detail. FIG. 4 is a perspective view of the bed 11 constituting the base portion 10. FIG. 5 is a plan view of the bed 11 and the members fixed to the bed 11. FIG. 6 is a perspective view of the bed 11 and the members fixed to the bed 11.

Referring to FIG. 4, the bed 11 is a one-piece member configured entirely with a steel plate. Generally, the bed 11 has a hole 103 formed at the central portion, centered on the rotational axis R. A first recessed portion 101, which is a ring-shaped recess, is formed concentrically with the hole 103. A second recessed portion 105 is formed contiguous with the first recessed portion 101. The second recessed portion 105 is a recess that reaches an end surface 11e of the bed 11. Screw holes 13 penetrating through the bed 11 in the thickness direction (Z axis direction) are formed at four positions of the bed 11. The screw holes 13 can be utilized to secure the bed 11 to an external member.

The hole 103 has a diameter approximately equal to the diameter of the inner circumferential surface of the outer ring 71 of the bearing 70 (FIG. 3). A second annular portion 104 is provided at the periphery of the hole 103. The second annular portion 104 has a plurality of screw holes 17 formed at equal intervals in the circumferential direction to penetrate therethrough in the thickness direction of the bed 11 (in the Z axis direction). The first annular portion 102 is along the outer periphery of the second annular portion 104. The outer ring 71 of the bearing 70 (FIG. 3) is spigot-fitted to a stepped portion formed by the inner circumferential surface 102b of the first annular portion 102 and an upper surface 104a of the second annular portion 104.

FIG. 5 shows some of the members fixed to the bed 11. Referring to FIG. 5, on the upper surface 101a of the first recessed portion 101, a first insulator 53 is placed, which is an insulating film corresponding to the shape of the first recessed portion 101. On the first insulator 53, the coils 52 are placed. Each coil 52 is a flat, annularly wound coreless coil. Fifteen coils 52 constitute the coil row 57 forming a portion of an annular ring. The coils 52 are three-phase coils. In the coil row 57, the coils are arranged repeatedly in the order of U phase, V phase, and W phase from one end. While the coil row in Embodiment 1 contains 15 coils, the number and arrangement of the coils included in a coil row can be changed according to the motor size, the desired torque, and the like. Three additional coils 52 may be placed to form an annular coil row around the entire circumference of the first recessed portion 101. The coils 52 are each fixed to the bed 11 with a screw 41 via a collar 42, together with a substrate 14 (FIG. 6).

The support base 12 and the cover 61 are fixed to the bed 11. The cover 61 has an end surface 61b on the center side formed in an arc shape to face the outer circumferential surface 21a of the placement portion 21 of the table 20 with a small gap therebetween. Inside the cover 61, components such as encoder signal lines, power lines, and others (not shown) are housed.

FIG. 6 is a perspective view corresponding to FIG. 5 with the substrate 14 added. Referring to FIG. 6, an upper surface 14a of the substrate 14 is configured to be at approximately the same height as the upper surface 11a of the bed 11 and the upper surface 102a of the first annular portion 102. An insulating film or other insulator may be attached to the upper surface 14a of the substrate 14.

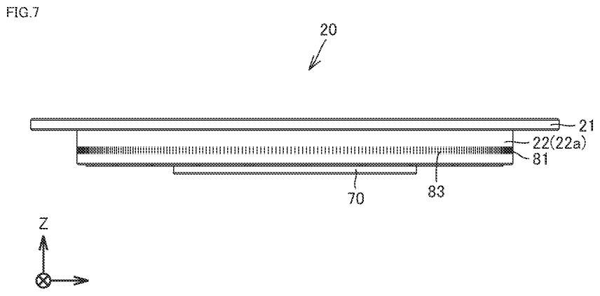

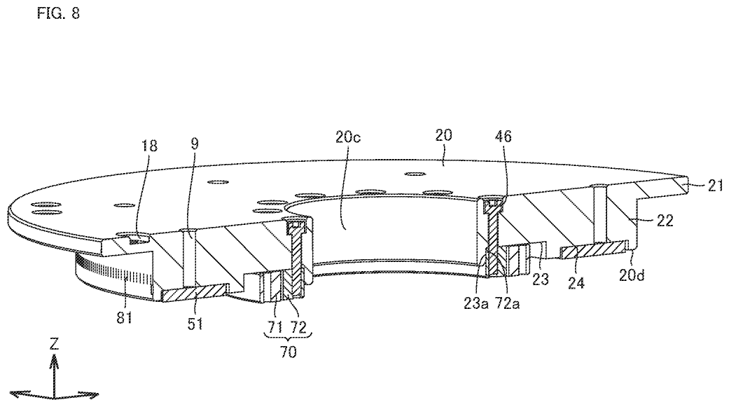

The rotating side of the rotary table device, i.e., the table 20 and members fixed to the table 20 of the rotary table device 1, will now be described in detail. FIG. 7 is a plan view of the table 20 and the bearing 70. FIG. 8 is a perspective cross-sectional view of the table 20 and the bearing 70 shown in FIG. 7. FIG. 9 shows the underside of the table 20. FIG. 9 is a plan view of the table 20 and the members fixed to the table 20.

Referring to FIG. 7, the scale 81 is printed around the entire circumference of the outer circumferential surface 22a of the shaft portion 22 of the table 20. Here, “printed” means that detectable elements that can be detected using a sensor are provided, and includes the general idea that there are marks formed by engraving by laser machining or etching, printing, transferring, writing, or the like. The scale 81 is a set of a large number of graduations 83. The scale 81 is directly printed on the outer circumferential surface 22a. Here, “directly printed” means that the graduations 83 are formed directly on the surface of the outer circumferential surface 22a, without the intermediary of a seal, ribbon, or the like. The graduations 83 are preferably fine recesses (slits) formed on the outer circumferential surface 22a by laser machining or etching. For example, the graduations 83 may be recesses formed on the outer circumferential surface 22a with lengths of 0.2 mm to 10 mm and depths of 0.1 μm to 100 μm. The graduations 83 can be spaced from each other by, for example, 1 μm to 100 μm. The graduations 83 may be formed at equal intervals, or the intervals may be different in some portions. The graduations 83 may be identical over the entire circumference. Furthermore, for example, as a part of, or in addition to, the graduations 83, a reference mark indicating the origin position or a specific position may be formed. In addition, the graduations at regular intervals may be made different in length and width from other graduations, so that they can be distinguished from the other graduations.

Referring to FIG. 8, the table 20 has a hollow central portion. The table 20 has an inner circumferential surface 20c that is flush throughout the placement portion 21 and the shaft portion 22. The configuration of the table 20 in which the central portion is hollow and the scale 81 is provided directly on the outer circumferential surface 22a of the shaft portion 22 enables more weight reduction of the rotating section. On a bottom surface 20d of the table 20, a first annular portion 23 and a second annular portion 24 are formed, which are annular recessed portions extending along the circumferential direction of the table 20. The bearing 70 is disposed in the first annular portion 23. The bearing 70 is placed such that an inner circumferential surface 72a of the inner ring 72 of the bearing 70 comes into contact with an inner circumferential surface 23a defining the first annular portion 23. The magnets 51 are disposed in the second annular portion 24. The thicknesses of the magnets 51 and the depth of the second annular portion 24 are approximately the same. The magnets 51 are substantially completely accommodated in the second annular portion 24, protruding only slightly from the bottom surface 20d of the table 20.

Referring to FIG. 9, a magnet 51 is a plate-shaped magnet having an approximately trapezoidal surface converging toward the center of rotation. Twenty-three magnets 51 arranged adjacent to each other constitute the magnet row 56. The magnets 51 are disposed around the entire circumference of the second annular portion 24. The magnet row 56 is an annular magnet row. In the magnet row 56, the magnets 51 are arranged such that the N and S poles alternate. It should be noted that the number of magnets and the manner of arrangement thereof are not limited thereto, and can be changed as appropriate according to the size and capability of the magnets, the required torque, and the like. For example, the magnets 51 may be adhered to the table 20 with an adhesive, or may be secured to the table 20 solely with the magnetic force of the magnets 51. The magnet row 56 is positioned to face the coil row 57 (FIG. 5).

The motor 50 of the rotary table device 1 will now be described.

Referring to FIGS. 2, 5, and 9, the magnet row 56 composed of the magnets 51 and the coil row 57 composed of the coils 52 constitute the motor 50. The table 20 also serves as a magnet yoke forming the flux path of the magnets 51. The coils 52 are supplied with electric power from connections (not shown) corresponding to the three phases of U, V, and W, respectively, through power lines (not shown). In the rotary table device 1, the substrate 14 is interposed between the magnets 51 and the coils 52, so the heat generated in the coils 52 during power supply is difficult to be transferred to the magnets 51. This configuration can reduce the decrease in magnetic flux density due to the temperature rise of the magnets 51, thereby suppressing the decrease in output of the motor 50. Furthermore, an air flow caused by the rotation of the table 20 is expected to air cool the magnets 51. The rotary table device 1 does not have a ring scale on the outer periphery of the shaft portion. Thus, the outer circumferential surface 22a of the shaft portion 22 is exposed to the outside of the device. The magnets 51 are also disposed at positions near the outside of the device, thus ensuring a better air cooling effect.

The size of the rotary table device will now be described. Although the size of the rotary table device 1 is not particularly limited, the configuration of printing the scale directly on the outer circumferential surface of the table shaft portion provides an infinite rotary table device that is unconventionally reduced in size. For example, an infinite rotary table device is configurable with the outside diameter of the table 20 of 100 mm and the size of the bed of 100 mm×115 mm. Needless to say, not limited to these sizes, the outside diameter of the table can be from about 10 to about 1000. The size of the bed can be from about 10 mm to about 1020 mm on each side.

### Embodiment 2

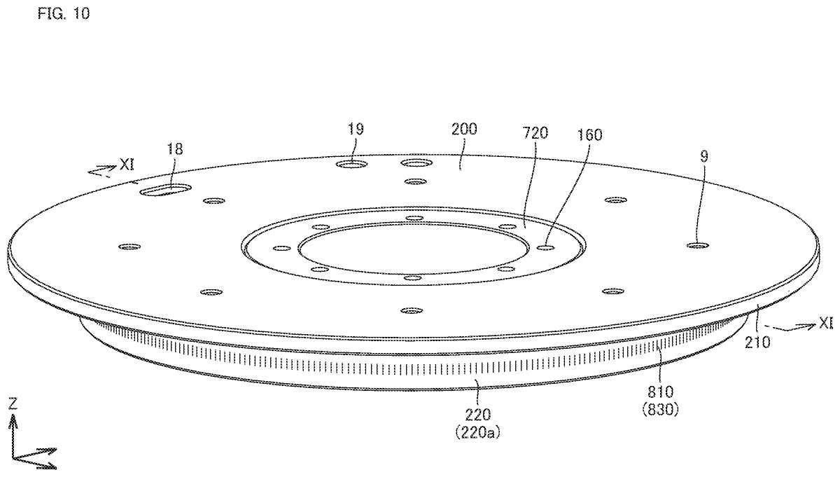

A description will now be made of Embodiment 2 of the rotary table device according to the present disclosure. Referring to FIGS. 10 to 12, a rotary body 200 is a rotating portion constituting the rotary table device of Embodiment 2 according to the present disclosure. For the configuration of the rotary table device other than the rotary body 200, the configuration of the rotary table device 1 described above can be applied with modifications as required. A major difference of the rotary body 200 from the table 20 of Embodiment 1 is that it is a single component obtained by integrating the table and the outer ring of the bearing. This difference will mainly be described below. The configurations identical to those of Embodiment 1 will be denoted by the same reference signs, and the description thereof will not be repeated.

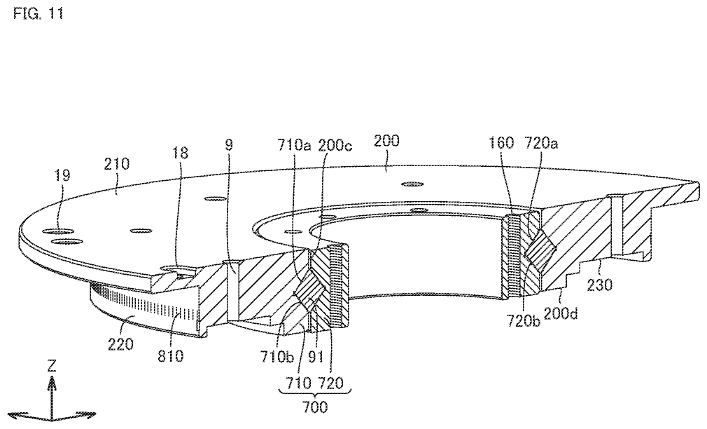

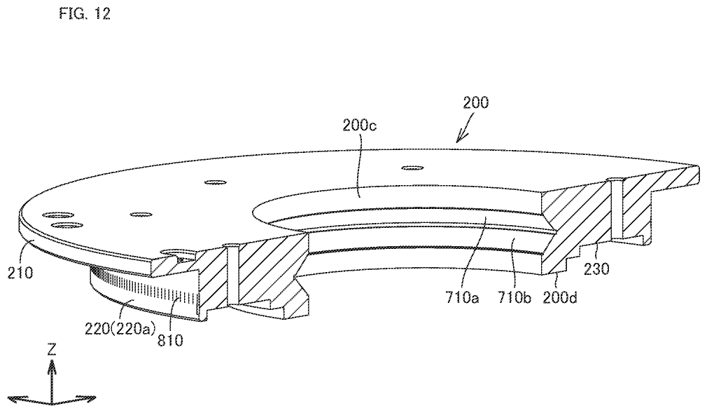

FIG. 10 is a perspective view of the rotary body 200 and an inner ring 720. FIG. 11 is a cross-sectional view taken along XI-XI in FIG. 10. FIG. 12 is a perspective cross-sectional view of the XI-XI section in FIG. 10, with the inner ring 720 omitted.

Referring to FIG. 10, the rotary body 200 includes a placement portion 210 of a hollow disk shape, and a shaft portion 220 located below the placement portion 210 and having a smaller outside diameter than the placement portion 210. The placement portion 210 has an upper surface formed to be flat. The placement portion 210 and the shaft portion 220 are integrally formed to be a single component. The shaft portion 220 has an outer circumferential surface 220a on which a scale 810 is printed around the entire circumference. The scale 810, as with the above-described scale 81, is composed of graduations 830 formed directly on the surface of the outer circumferential surface 220a by laser machining, etching, or the like.

Referring to FIG. 11, the rotary body 200 has an inner circumferential surface 200c on which raceway surfaces 710a, 710b are formed, which are rolling surfaces for rolling elements 91 of a bearing 700. In other words, the rotary body 200 is a member which is an integral configuration of a table and an outer ring of a bearing in a rotary table device. The rotary body 200 includes an outer ring 710 of the bearing. An inner circumferential side of the shaft portion 220 functions as the outer ring 710 which, together with the inner ring 720 and the rolling elements 91, constitutes the bearing 700. The rolling elements 91 are columnar rollers. The bearing 700 is a crossed roller bearing. The inner ring 720 is fixed to the bed (not shown) by screws (not shown) inserted in screw holes 160.

Referring to FIGS. 11 and 12, the rotary body 200 has a bottom surface 200d on which a first annular portion 230 is formed, which is an annular recessed portion extending in the circumferential direction of the rotary body 200. A plurality of plate-shaped magnets are arranged in the first annular portion 230. The raceway surfaces 710a and 710b are formed on the inner circumferential surface 200c. During production, the raceway surfaces 710a, 710b and the outer circumferential surface 220a can be machined in one chucking, enabling production with rational production steps.

In the rotary body 200, the scale 810 is printed directly on the outer circumferential surface of the shaft portion 220, and the table and the outer ring of the bearing of a rotary table device are integrated together. With these configurations, a rotary table device that is more compact and capable of infinite rotation can be obtained with rational production steps.

### (Other Variations)

In the rotary table device 1, the outer ring 71 of the bearing 70 is fixed to the bed and the inner ring 72 is fixed to the table 20. Alternatively, the device may have a structure in which the outer ring of the bearing is fixed to the table and the inner ring is fixed to the bed. The rotary body 200 is a member that includes the outer ring 710 of the bearing 700. Alternatively, it may have a structure in which the table and the inner ring of the bearing are integrated together. These may be selected as appropriate, taking into account the layout of the components, the size and mass of the device, and the like.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

1: rotary table device; 10: base portion; 11: bed; 12: support base; 14: substrate; 20: table; 21, 210: placement portion; 22, 220: shaft portion; 23, 230: first annular portion; 24: second annular portion; 35: gap; 41, 46, 47, 48: screw; 42: collar; 9, 13, 16, 17, 160: screw hole; 18, 19: mounting hole; 50: motor; 51: magnet; 52: coil; 53: first insulator; 56: magnet row; 57: coil row; 61: cover; 70, 700: bearing; 71, 710; outer ring; 72, 720: inner ring; 81, 810: scale; 82: encoder head; 83, 830: graduation; 91: rolling element; 101: first recessed portion; 102: first annular portion; 103: hole; 104: second annular portion; 105: second recessed portion; and 200: rotary body.

1. A rotary table device comprising:
a base portion;
a bearing;
a table rotatably supported with respect to the base portion via the bearing; and
a motor operable to rotate the table in a rotational direction of the bearing,
the motor including
a coil row fixed to the base portion and having a plurality of flat, annularly wound three-phase coreless coils arranged side by side, and
a magnet row arranged opposite to the coil row and fixed to the table, and having a plurality of plate-shaped magnets arranged side by side in a circumferential direction of the table with alternating magnetic poles;
the table having an outer circumferential surface on which a scale is printed around an entire circumference of the table,
the base portion having mounted thereon a sensor for reading the scale.

2. The rotary table device according to claim 1, wherein
the coil row is a row of the coreless coils arranged to constitute a portion of an annular ring, and
the magnet row is an annular row of the magnets arranged around the entire circumference of the table.

3. The rotary table device according to claim 1, wherein
the table includes
a disk-shaped placement portion having an upper surface formed to be flat, and
a shaft portion located below the placement portion and having a smaller diameter than the placement portion,
the scale is printed on an outer circumferential surface of the shaft portion, and
an encoder head including the sensor is placed on the base portion such that the encoder head as a whole is positioned under the placement portion.

4. The rotary table device according to claim 1, wherein graduations constituting the scale are recesses formed on the outer circumferential surface of the table with lengths of 0.2 mm to 10 mm and depths of 0.1 μm to 100 μm.

5. The rotary table device according to claim 1, wherein the table and an outer ring of the bearing are configured as a one-piece component.
